(19) United States
(12) Patent Application Publication
(10) Pub. No.: US 2008/0024063 A1
(43) Pub. Date: Jan. 31, 2008

(54) PLASMA DISPLAY PANEL AND METHOD FOR MANUFACTURING THE SAME

(76) Inventor: Hiroshi Yamanaka, Miyazaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/626,870

(22) Filed: Jan. 25, 2007

(30) Foreign Application Priority Data
Jul. 28, 2006 (JP) JP2006-205574

(51) Int. Cl. H01J 17/49

(52) U.S. Cl. 313/583

(57) ABSTRACT

Providing a technology capable of coping with the problem in accuracy of the electrode pattern forming caused by high density formation of an electrode and the like, according to higher definition of a PDP. A plurality of address electrodes, which are formed, for example, on a front face of a back glass substrate, have an electrode terminal in a peripheral portion of a PDP. The back glass substrate on the peripheral portion has a conduction hole, passing between the front face and a back face, provided therein. On the peripheral portion, a first group of the electrodes terminals of the plurality of address electrodes are formed and disposed as front electrodes on the front face, and a second group of electrodes terminals are formed and disposed as back electrodes so as to extend up from the front face to the back face through the conduction hole and a conduction electrode.

### CROSS-REFERENCE TO RELATED APPLICATION

The present application claims priority from Japanese patent application No. JP 2006-205574 filed on Jul. 28, 2006, the content of which is hereby incorporated by reference into this application.

### TECHNICAL FIELD OF THE INVENTION

The present invention relates to a technology of a plasma display panel (PDP) and a display apparatus including the same, particularly to a structure of an electrode terminal portion formed on a panel.

### BACKGROUND OF THE INVENTION

In conventional PDPs, a terminal of an electrode (a terminal portion) is formed and disposed on one face side (in particular, an inner face of a panel on which an element or a structure is formed) of a substrate (glass substrate), in both a front substrate and a back substrate. In general, conventional methods for forming an electrode terminal portion in a PDP and structures of such a terminal portion are largely classified into two kinds. One method (a first method) is a method in which a metal material (which in many cases has a three-layer structure of Cr (chromium), Cu (copper), and Cr) composing an electrode structure (electrode pattern) including a terminal portion, is formed on a glass substrate by photolithography. The other method (a second method) is a method in which a structure composed of a metal glass paste (a paste material mainly composed of Ag (silver) and including glass) is formed on a glass substrate by pattern printing or by photosensitive paste printing plus photolithography.

As a PDP has a higher definition in recent years, the pitch of formation and disposition of an electrode including a terminal portion, of a PDP has tended to be narrower.

As a PDP has a higher definition, the second method that uses a metal glass paste as mentioned above is preferable as a method for forming an electrode including a terminal portion in a PDP, in securing electrical connectivity. However, the second method has a problem in securing accuracy of the electrode pattern forming. Besides, a problem of migration (ionic migration) specific to an Ag material, particularly to one used as a metal glass paste, has become more serous. Specifically, a short circuit between electrode terminal portions caused by migration would cause a malfunction in the apparatus.

Some manufacturers use Au (gold) paste printing to form an electrode terminal portion in order to avoid the above-mentioned migration. However, in such an Au paste printing, using pattern printing, which is a low cost, causes a problem in accuracy of the electrode pattern forming.

Therefore, it is desirable to form the electrode pattern on a substrate by the second method as a method for manufacturing a PDP, preferably using an AG or Au material as a metal glass paste, as well as to secure accuracy of the electrode pattern forming.

### SUMMARY OF THE INVENTION

In view of the foregoing, it is an object of the present invention to provide a technology capable of coping with the problem in accuracy of the electrode pattern forming caused by high density formation/disposition of an electrode according to higher definition of a PDP, more specifically, reduced pitches between electrode terminal portions, migration, and the like, without dependence on selection of an electrode material.

An outline of typical elements of the invention disclosed in this application is described briefly as follows. To achieve the above-mentioned object, the invention is a PDP technology and includes technological means and structures to be discussed later.

To cope with above-mentioned problem, in a PDP according to the invention, devises in a panel structure, specifically, in forming and disposing an electrode terminal portion are performed. More specifically, in the PDP according to the invention, an electrode terminal portion is formed and disposed on both front and back faces of a main plate portion (typically, glass substrate) of at least one of a front substrate structure and a back substrate structure, on which an electrode pattern is formed and disposed. In conventional PDPs, the electrode terminal portion has been formed and disposed on either of front or back face of the substrate. By using the structure of the invention, addressing a higher definition PDP is achieved. Simply put, by forming and disposing an electrode terminal portion using both front and back faces of the substrate, it is made possible to cope with twice the degree of definition of a conventional PDP structure.

The structure of the PDP is, for example, as follows. Basically, in the PDP, a first (front face) and a second (back face) substrates (substrate structure) both composed essentially of glass and the like are opposed and combined. A plurality of electrodes (X/Y electrodes, address electrode, etc.) of at least one type are formed and disposed on at least one face of at least one of the first and second substrates. An image is displayed by applying a voltage from an external drive circuit to the electrodes to utilize a discharge of gas sealed in a discharge space between the substrates.

In the invention, terminals of the plurality of electrodes on the first face of the substrate of the PDP are disposed in a peripheral portion of the PDP so as to be electrically connected to an external circuit side. The terminal portions of the plurality of electrodes in the peripheral portion are formed and disposed on both the first and second faces separately using a hole portion and the like provided in the substrate. In groups of the terminal portions of the electrodes, one group (first group) is disposed on a front face (first face) and the other group (second group) is disposed on a back face (second face). By disposing the electrode terminal portions on the first and second faces separately, intervals between the electrode terminal portions become larger on one face. To establish conduction of an electrode from the first face to the second face, a hole portion (via hole, contact hole) is provided in a prescribed position of the substrate. An electrode portion (conduction electrode) is also formed in the hole portion using a conductive material.

A method for manufacturing the PDP is, for example, as follows.

(1) Hole portion forming step: The above-mentioned hole portion is formed in a prescribed position of the substrate composing the PDP, such as glass substrate, or a substrate structure including such a substrate, by machining using a drill, waterjet (ultra high water pressure) or the like.

(2) Continuity electrode forming step: The conduction electrode for electrically connecting the electrode portion on the first face to the electrode portion on the second face is formed by embedding a conductive material in the hole portion of the substrate or filling the hole portion with the material, using either one or some of the second method, offset printing, inkjet, dispenser, die coat, or the like.

(3) Front electrode forming step: A terminal portion (front electrode) is formed on the first face of the substrate using, for example, a similar method to that shown in the step (2).

(4) Back electrode forming step: A terminal portion (back electrode) is formed on the second face of the substrate using, for example, a similar method to that shown in the step (3).

(5) Electrode calcining step: After the steps (1) to (4) are performed, all the electrode portions are calcined. By this step, manufacturing the PDP is completed. As a matter of course, the electrode parts, such as the terminal portions on the first and second faces and the conduction electrodes portions, must be electrically connected, and insulated from adjacent electrodes. The order of the steps (2) to (4), associated with formation of the entire electrode pattern, may be changed. Alternatively, some of the steps may be combined or one step may be divided into some steps.

An advantageous effect obtained by typical elements of the invention disclosed in this application is described briefly as follows. According to the invention, it is possible to cope with the difficulty with electrode pattern forming accuracy caused by high density formation/disposition of an electrode according to a higher definition of a PDP, more specifically, reduced pitches between electrode terminal portions, migration, and the like, without depending on selection of an electrode material.

In particular, it is possible to cope with the migration problem that is attributed to a material, such as silver (silver glass paste), used as a material of an electrode including an electrode terminal portion, and thus to secure product reliability. Further, as with conventional PDPs, it is possible to use pattern printing, which is low cost, in forming an electrode, and thus to reduce the cost.

### BRIEF DESCRIPTION OF THE DRAWINGS

FIG. 1 is a drawing showing a configuration of a PDP according to an embodiment of the present invention, seen from a front side of the PDP.

FIG. 2 is a drawing showing a configuration of a cross sectional view of the PDP according to an embodiment of the present invention.

FIG. 3 is a drawing showing a configuration of an electrode terminal portion, and the like on front and back faces of a substrate in a part of a peripheral portion of the PDP according to an embodiment of the present invention.

FIG. 4A is a drawing showing a configuration of an electrode terminal portion and the like in a cross sectional view of the substrate at a position of the electrode terminal portion of the PDP according to a embodiment of the present invention.

FIG. 4B is a drawing showing a configuration of an electrode terminal portion and the like in a cross sectional view of the substrate at a position of a conduction hole of the PDP according to a embodiment of the present invention.

FIG. 5 is a drawing showing a configuration of a electrical connection portion to an external circuit portion in a cross sectional view of the substrate in a part of a peripheral portion of the PDP according to a embodiment of the present invention.

FIG. 6A is a drawing showing a configuration of an electrode terminal portion and the like on a face of a substrate of a PDP according to a premised technique of the present invention.

FIG. 6B is a drawing showing a cross sectional view at a position of the electrode terminal portion to show a configuration of an electrode terminal portion and the like of a PDP according to a premised technique of the present invention.

### DESCRIPTION OF THE PREFERRED EMBODIMENTS

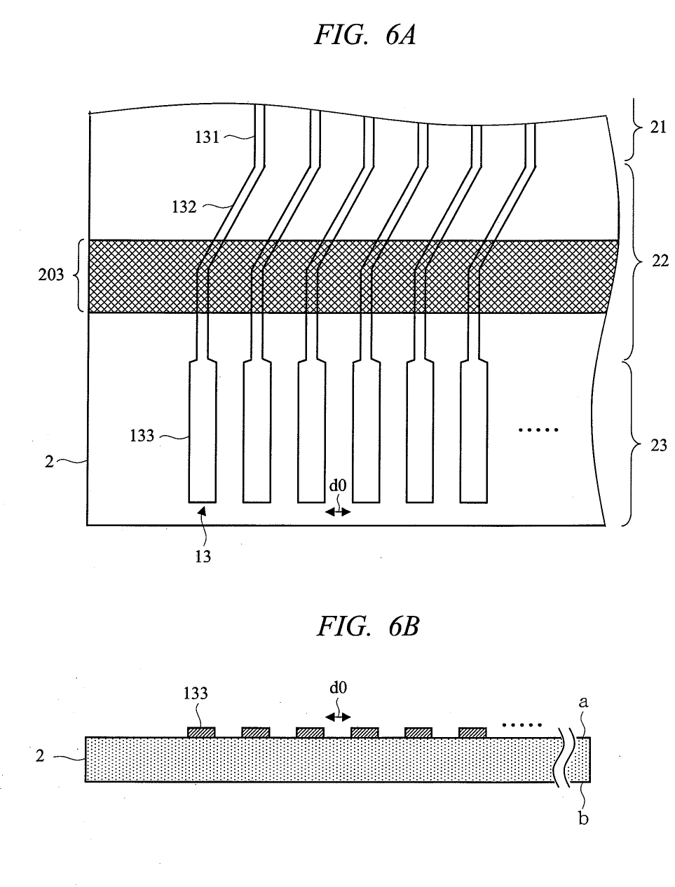

An embodiment of the invention will be described in details with reference to the accompanying drawings. In the drawings, identical elements are basically denoted by the same reference symbols respectively and will not be described repeatedly. FIGS. 6A and 6B show a configuration of a premised technique of the invention to facilitate understanding of the invention.

With reference to FIGS. 1 to 5, a three electrode surface discharge type PDP 10 according to the embodiment of the invention is described. In this embodiment, electrode terminal portions of address electrodes on a back substrate are formed alternately on front and back faces of a glass substrate.

(Front Face of PDP)

In FIG. 1, a configuration of the PDP 10 seen from a front face (display window) side is shown. The surface discharge type PDP 10 is mostly configured by combining a front substrate (front structure) 201 and a back substrate (back structure) 202, both are composed mainly of a glass substrate. Discharge space between the front substrate 201 and the back substrate 202 is sealed by a sealing area (or sealing object, PDP sealing part) 203 and vacuum-hold.

A display area 110 inside the sealing area 203 is an area in which an image, which corresponds to a matrix of cells composed of groups of various kinds of electrodes and the like, is displayed. Outside the sealing area 203, there are provided extra areas that are used for electrical connection to an external drive circuit or other purposes. The front substrate 201 has an area 23a on both sides of FIG. 1, and the back substrate 202 has an area 23b at a top and a bottom of FIG. 1. An exhaust hole 125 is used when discharge gas is sealed in.

Further, the PDP 10 is fixed and held on a chassis that is disposed on a back of the PDP 10. A circuit portion, such as a drive circuit, disposed on the back of the chassis is electrically connected to the terminal portions of the electrodes of the PDP 10. In this way, the PDP apparatus (PDP module) is configured.

(Cross Section of PDP)

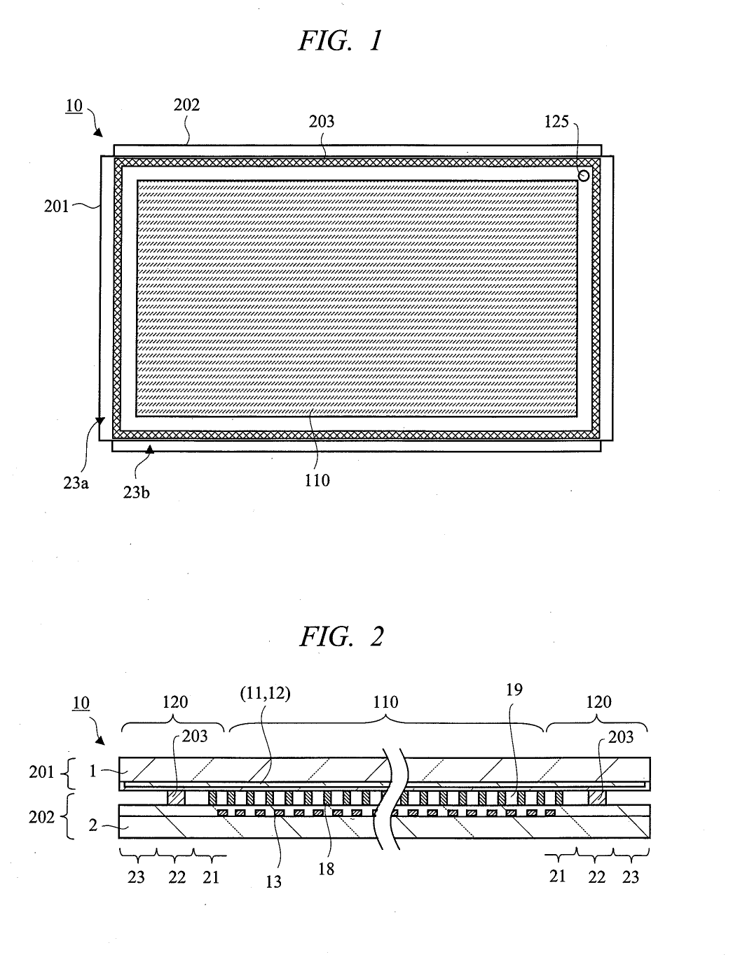

Next, a configuration of a cross section of the PDP 10 will be described with reference to FIG. 2. FIG. 2 illustrates a cross section of the PDP 10 in a transverse (row) direction. A cross section in a vertical (column) direction should be understood similarly.

Discharge space 19 between the front substrate 201 and the back substrate 202 is sealed by the sealing area 203, which is formed and disposed in a second area 22 of a peripheral portion (frame) 120 of the PDP 10.

On an inner face (downward face in FIG. 2) of a front glass substrate 1 of the front substrate 201, an X electrode 11 and a Y electrode 12, which are both a plurality of display electrodes (sustain electrode) generating surface discharge, are formed so as to extend in a transverse direction, and then covered with a dielectric layer or the like. On an inner face (upward face in FIG. 2) of a back glass substrate 2 of the back substrate 202, a plurality of address electrodes 13, which are used for address operation, are formed so as to extend in a vertical direction, and then covered with a dielectric layer or the like. Further, structures such as a partition wall 18 and a fluorescent substance (not shown) are formed on the inner face of the back glass substrate 2 including address electrodes 13. The terminal portions of the various kinds of electrodes are electrically connected to a drive circuit portion side.

(Premised Technique)

Now a configuration of a PDP of a premised technique will be described with reference to FIGS. 6A and 6B for comparison. For example, FIG. 6A illustrates a structure of terminal portions of address electrodes 13 on a back substrate in a part of a peripheral portion of the PDP as seen from above the back glass substrate 2. X electrodes and Y electrodes on a front substrate should be understood similarly.

For convenience, the address electrodes 13 is structurally classified into three parts: an electrode body 131, which lies in a first area 21 inside the sealing area 203, a leader 132, which lies in an second area 22 that partly overlaps the sealing area 203, and an electrode terminal portion 133, which lies on a third area 23 near an edge of the PDP. These parts are formed continuously using a conductive material. The electrode body 131 is a part that extends on a display area of the PDP. The electrode terminal portion 133 is a part that is electrically connected to a drive circuit side, and lies outside the sealing area 203 and extends up to a prescribed connecting position to outside near a side face of the PDP. The leader 132 is a part that electrically connects the electrode body 131 to the electrode terminal portion 133.

FIG. 6B shows a cross section of the back glass substrate 2 and the address electrodes 13, at a position of the electrode terminal portion 133, of the PDP in FIG. 6A. A plurality of electrode terminal portions 133 are formed only on a front side (A) of the back glass substrate 2. For electrical connection to outside, the electrode terminal portions 133 are formed such that a width thereof is larger than that of the electrode body 131. As the PDP has a higher definition, pitches (DO) between the adjacent electrode terminal portions 133 become increasingly narrower. Further, occurrence of migration in the electrode terminal portion 133 may cause a short circuit between the electrode terminal portions 133.

(Electrode Terminal Portion)

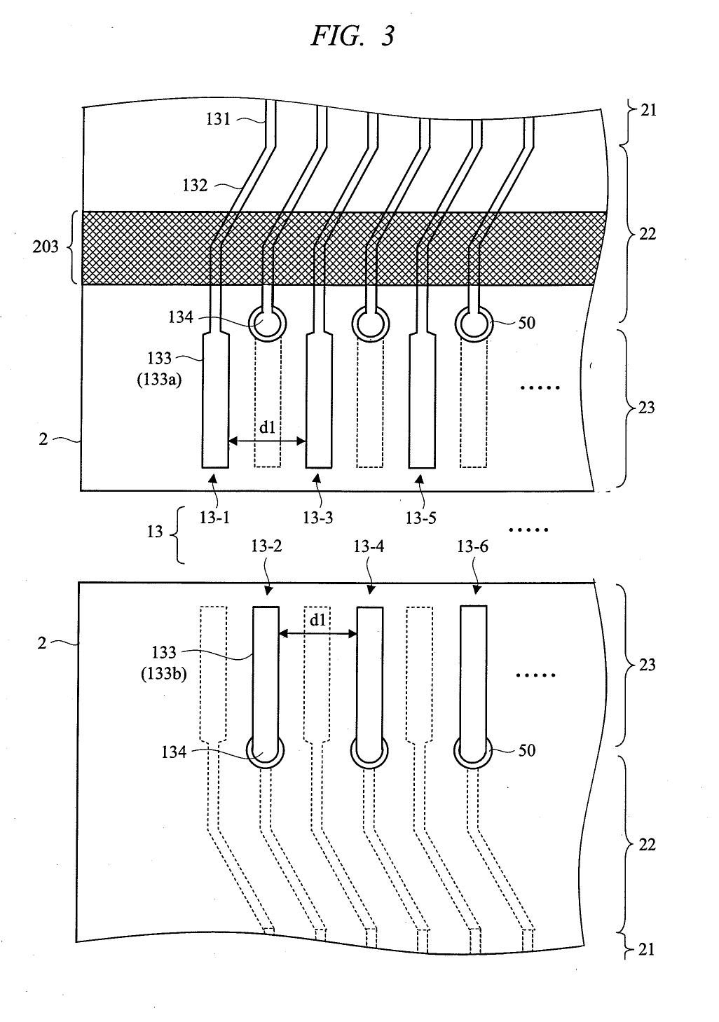

Now a structure of a vicinity of the electrode terminal portion 133 will be described as a distinctive structure of the PDP 10 with reference to FIG. 3. FIG. 3 illustrates structures of the address electrodes 13 on the back substrate 202 of the PDP 10 as seen from both the front side (A) and the back side (B) of the back glass substrate 2 in a part of the peripheral portion 120 of the PDP 10. This distinctive structure can be also applied to the X electrode 11 and the Y electrode 12 on the front substrate 201.

For convenience, the peripheral portion 120 of the PDP 10 is classified into the first area 21 to the third area 23. The first area 21 is an area near an end of the electrode body 131 in the display area 110. The third area 23 is an area at an edge of the PDP 10, in which the electrode terminal portion 133 is disposed. The second area 22 is an area between the first area 21 and the third area 23, partly overlaps the sealing area 203, and in which the leader 132 of the address electrodes 13 is disposed.

The address electrode 13 is structurally classified into four parts: the electrode body 131, which lies in the first area 21, the leader portion 132, which lies in the second area 22, the electrode terminal portion 133, which lies in the third area 23, and the conduction electrode portion 134, which is formed in the conduction hole 50. Further, the electrode terminal portion 133 is classified into a front electrode 133A, which lies on the front face (A) of the back glass substrate 2, and a back electrode 133B, which lies on the back face (B) of the back glass substrate 2.

As a conductive material to form an electrode pattern including the parts (131 to 134) of the address electrode 13, for example, a silver paste is used. Electrical contact between the parts (131 to 134) of the electrode pattern is secured.

The electrode body 131 extends straight in the display area 120 of the PDP 10. The electrode terminal portion 133 is electrically connected to the drive circuit side, lies outside the sealing area 203 and extends to a prescribed connecting position to outside near a side face of the PDP 10. The leader portion 132 partly overlaps the sealing area 203 and electrically connects the electrode body 131 to the electrode terminal portion 133.

FIG. 3 illustrates first to sixth address electrodes (13-1 to 13-6) of the address electrodes 13, as examples, which are arranged sequentially with the first address electrode located at an end. The seventh and later address electrodes are arranged in the same way. The odd-numbered address electrodes (13-1, 13-3, 13-5, . . . ) makes up a first group, and even-numbered ones (13-2, 13-4, 13-6, . . . ) makes up a second group.

On the back glass substrate 2, the electrode terminal portions 133 of the first group of the address electrodes 13 are formed as front electrodes 133A straight from the leader portions 132 up to a prescribed connecting position to outside near a side face of the PDP 10 on the front face (A), as with conventional PDPs. The electrode terminal portions 133 of the second group of the address electrodes 13 are formed as back electrodes 133B on the back face (B). Therefore, the second group of the address electrodes 13 are disposed so as to extend from the leader portions 132 on the front face (A) through the conduction electrode portion 134 in the conduction hole 50 up to the back face (B), then to be electrically connected to the back electrodes 133B, and further to extend up to a prescribed connecting position to outside.

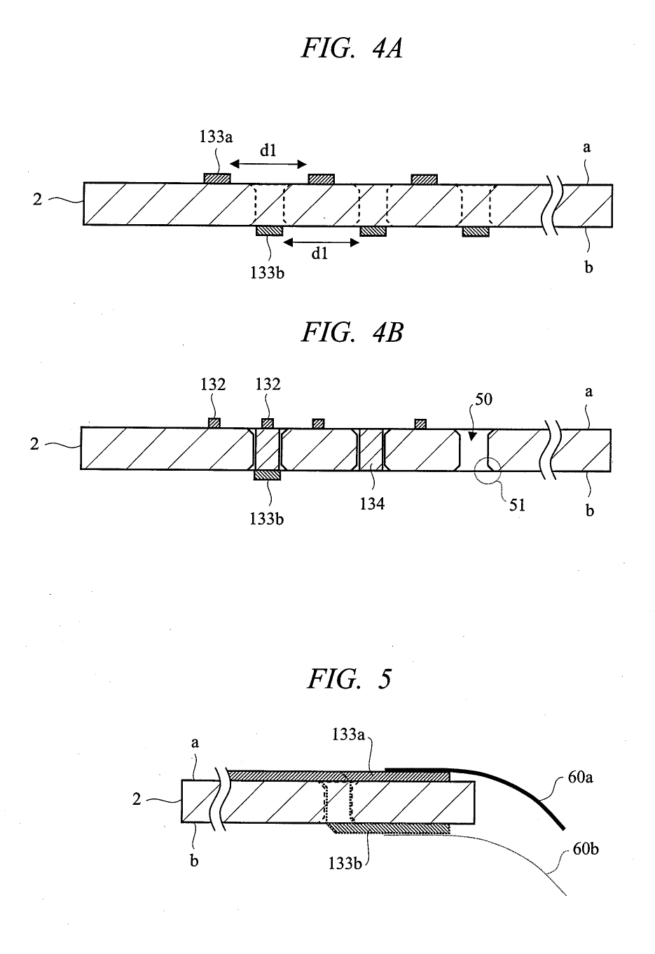

FIG. 4 illustrates cross sections of the back glass substrate 2 and the address electrodes 13 of the PDP 10 as shown in FIG. 3, at a position of the electrode terminal portion 133. As shown in FIG. 4A, the front electrodes 133A, which are the first group of electrode terminal portions 133, are formed at equal intervals on the front face (A) of the back glass substrate 2, and the back electrodes 133B, which are the second group of electrode terminal portions 133, are formed at equal intervals on the back face (B). For electrical connection to outside, the electrode terminal portions 133 are formed such that a width thereof is larger than that of the electrode body 131. The electrode terminal portions 133 are disposed alternately between the front face (A) and the back face (B), so pitches (D1) between the adjacent electrode terminal portions 133 are sufficiently secured.

As shown in FIG. 4B, the conduction electrode portion 134 is formed in the conduction hole 50, and the leader portion 132 on the front face (A) and the electrode terminal portion 133 on the back face (B) are electrically connected to the conduction electrode portion 134. Although conduction hole 50 can be a simple cylindrical hole, in this embodiment, the conduction hole 50 has a taper shape portion 51 on both the front face (A) and the back face (B). Hence, electrical connection between the conduction electrode portion 134 and the leader portion 132, and between the conduction electrode portion 134 and the electrode terminal portion 133 are secured or are made satisfactory.

According to the above-mentioned configuration, it is possible to cope with reduced pitches between the adjacent electrode terminal portions 133 due to a high definition of the PDP 10. Even if migration occurs in the electrode terminal portion 133, it is possible to prevent a short circuit between the electrode terminal portions 133.

(Manufacturing Method)

As a method for manufacturing the PDP 10, a manufacturing method regarding the configurations as shown in FIGS. 3 and 4 will be described.

(1) To begin with, the conduction hole 50 is formed in the back substrate 2. By machining (for example, lathe type minute hole processing machine), one conduction hole 50 is formed every two electrode terminal portions 133 of the address electrodes 13 to be formed, from an edge of the PDP 10. In other words, the conduction hole 50 is formed in positions near ends of the leaders 132 outside the sealing area 203, corresponding to the second group of electrodes in this embodiment, which are even-numbered ones. While the conduction hole 50 is provided near a electrical connection between the leader portion 132 and the electrode terminal portion 133 in this example, it can be provided in another position.

A diameter of the conduction hole 50 is, for example, 50 μm or more to 500 μm or less. In forming the conduction hole 50, peripheral portions of the conduction holes 50 are processed to form the taper shape portion 51 in order to strengthen electric contact between the electrode parts to be formed later, or the like.

(2) Next, the conduction electrode portion 134 is formed in the conduction hole 50 by a method such as embedding a conductive material in the hole. The conduction electrode portion 134 electrically connects the leader portion 132 and the electrode terminal portion 133.

(3) Then, as the front electrodes 133A on the front face (A) and the back electrodes 133B on the back face (B), the electrode terminal portions 133 are formed by a method such as screen printing or photosensitive printing plus photolithography, using, for example, a silver paste as a conductive material. The electrode body 131 is also formed as have heretofore been formed.

By carrying out the above-mentioned steps (2) and (3), an electrode pattern with electrical contact between the parts (131 to 134) for the address electrodes 13 is formed. As a conductive material that makes up the electrode pattern, a single-element metal material, which contains one of silver, gold, aluminum, copper, nickel, platinum, palladium, and chromium, or a multi-element metal material, which contains at least one of the above-mentioned elements, or a metal glass paste material, which contains the above-mentioned metal material and a glass ingredient, is used.

(4) Subsequently, the electrode pattern is subjected to calcining, and then the structure as shown in FIG. 3 is completed.

Note that, in the above-mentioned manufacturing method, formation of the electrode terminal portions 133 (133A and 133B) or the like and formation of the conduction electrode portions 134 into the conduction holes 50 are carried out in the separate steps, but may be carried out in the same step. For example, after forming the leader portion 132 of the front face (A), the front electrode 133A, or the like, and the conduction electrode portion 134 in one step, formation of the back electrode 133B on the back face (B) and electric contact may be carried out in another step.

(Connecting Portion)

FIG. 5 illustrates an example of a configuration of a electrically connecting portion between the electrode terminal portions 133 of the address electrodes 13 on the back substrate 202 and the drive circuit portion (address drive circuit) side. The electrode terminal portion 133 is electrically wired and connected to the drive circuit portion on the chassis, using, for example, a flexible substrate (FPCB). The electrode terminal portion 133 is electrically connected to a terminal of the flexible substrate by a connector or by thermocompression bonding.

FIG. 5 illustrates a configuration in which two separate flexible substrates 60A and 60B are electrically connected to the electrode terminal portions (133A and 133B) on the front and back faces (A, B) of the back glass substrate 2 separately. Alternatively, a configuration in which one flexible substrate pinches the front and the back faces (A, B) is also acceptable.

Further, for example, as a material of a plate (a part other than structures such as electrode, dielectric layer, and partition wall) mainly constituting a substrate (back substrate 202) in which the conduction hole 50 is to be formed, an insulating material composed of any one of a ceramic, a polymeric material, and a metal, which meets panel requirement characteristics (requirements such as electrical insulation, strength, transparency of a display window) may be used. In other words, the substrate may be formed with any material other than a conventional glass, as long as it meets the panel requirement characteristics. In this case, the conduction hole 50 is more easily formed than when a substrate made of glass is used.

While the invention made by the inventor has been described concretely based the embodiment, the invention is not limited to the embodiment. As a matter of course, various modifications can be made to the invention without departing from the spirit and scope of the invention.

The present invention is applicable to a PDP including an electrode terminal portion.

What is claimed is:

1. A plasma display panel having a configuration in which first and second substrate structures are opposed and combined, a plurality of electrodes of at least one type extend in parallel and are disposed on at least one of the first substrate structure and the second substrate structure, and an image is displayed by applying a voltage to the electrodes to utilize a discharge of gas sealed in a space between the first and second substrate structures, the plasma display panel comprising:
terminal portions of the plurality of electrodes formed on a first face of at least one of the first and second substrate structures in a peripheral portion of the panel; and
a hole portion passing through the first face of the at least one of the first and second substrate structures and a second face opposite to the first face in the peripheral portion of the panel,
wherein a first group in the terminal portions of the plurality of electrodes is disposed on a side of the first face and a second group therein is disposed so as to extend on a side of the second face through the hole portion from the side of the first face.

2. The plasma display panel according to claim 1,
wherein the plurality of electrode portions are disposed at equal intervals alternately on the first and second faces.

3. The plasma display panel according to claim 1,
wherein the hole portion has a diameter of 50 μm or more to 500 μm or less, has a taper shape on the sides of the first and second faces of the substrate structure, and is positioned outside a sealing area disposed in the peripheral portion of the panel so as to vacuum-hold an area between the first and second substrate structures.

4. The plasma display panel according to claim 1,
wherein a flexible substrate for electrically connecting the terminal portions of the electrodes and a side of an external circuit is composed of two flexible substrates each independent from the first and second faces of the substrate structure, or composed of one flexible substrate pinching the first and second faces.

5. A method for manufacturing a plasma display panel having a configuration in which first and the second substrate structures are opposed and combined, a plurality of electrodes of at least one type extend in parallel and are disposed on at least one of the first substrate structure and the second substrate structure, and an image is displayed by applying a voltage to the electrodes to utilize a discharge of gas sealed in a space between the first and second substrate structures, the method comprising the steps of:
forming terminal portions of the plurality of electrodes on a first face of at least one of the first and second substrate structures in a peripheral portion of the display and forming a hole portion passing through the first face of the at least one of the first and second substrate structures and a second face opposite to the first face in the peripheral portion by machining using a drill or ultra high water pressure;
forming a conduction electrode portion by embedding a conductive material in the hole portion by using either one or some of pattern printing, inkjet, offset printing, dispenser, and die coat;
forming a first group of the terminal portions of the plurality of electrodes on a side of the first face in the peripheral portion; and
forming a second group of the terminal portions of the electrodes in the peripheral portion in such a manner that the second group of the terminals extend from the side of the first face through the conduction electrode portions of the hole portion to a side of the second face.
